(19) United States
(12) Patent Application Publication
(10) Pub. No.: US 2007/0144313 A1
(43) Pub. Date: Jun. 28, 2007

(54) Tool connecting device

(75) Inventor: Sheng Ming Chang, Taichung Hsien (TW)

Correspondence Address: CHARLES E. BAXLEY, ESQ., 90 JOHN STREET, THIRD FLOOR, NEW YORK, NY, 10038, US

(73) Assignee: Hsin Ying Enterprise Co., Ltd.

(21) Appl. No.: 11/710,648

(22) Filed: Feb. 23, 2007

Related U.S. Application Data
(63) Continuation-in-part of application No. 11/274,737, filed on Nov. 15, 2005.

(51) Int. Cl. B25B 23/16; B25G 1/00; B25G 1/04

(52) U.S. Cl. 81/177.75; 81/177.2

(57) ABSTRACT

A tool connecting device includes a shaft having a non-circular socket opening for receiving a non-circular rotatable member of a tool member to allow the tool member to be selectively tilted relative to the shaft to different angular position, a hexagonal protrusion is extended from the tool member for engaging with the shaft to anchor the rotatable member to the shaft and to prevent the tool member from being tilted relative to the shaft, the tool member has an engaging hole for engaging with a driving member, and a magnetic member may be disposed in the shaft for attracting the rotatable member of the tool member to the shaft.

The present invention is a continuation-in-part of U.S. patent application Ser. No. 11/274,737, filed 15 Nov. 2005, pending.

### BACKGROUND OF THE INVENTION

1. Field of the Invention

The present invention relates to a tool connecting device, and more particularly to a tool connecting device for connecting a tool member or a fastener or a work piece or a driven member to a shaft to allow the tool member or the fastener or the work piece or the driven member to be selectively secured to the shaft and rotated in concert with the shaft or to be rotated or driven by the shaft or to be selectively tiltable or slantable relative to the shaft to selected angular positions.

2. Description of the Prior Art

Typical tool connecting devices comprise a tool member or a tool bit or a fastener or a work piece secured to a mandrel with a split-ring and arranged to allow the tool bit to be selectively secured to the mandrel and rotated in concert with the mandrel or to be tiltable or slantable relative to the mandrel.

For example, U.S. Pat. No. 5,918,512 to Habermehl et al. discloses one of the typical replaceable bit screwdriver assemblies also comprising a tool bit secured to a mandrel with a split-ring and arranged to allow the tool bit to be selectively secured to the mandrel and rotated in concert with the mandrel or to be tiltable relative to the mandrel. However, an additional lever tool is required to be engaged into the mandrel to selectively disengage the tool bit from the mandrel.

U.S. Pat. No. 6,290,606 to Hodson discloses another typical polygonal ball drive systems for earth auger and also comprising an earth auger selectively coupled or attached to a drive member with a number of balls. However, the earth auger may not be selectively and solidly coupled or attached to the drive member to allow the earth auger to be rotated in concert with or to be rotated or driven by the drive member.

U.S. Pat. No. 6,874,392 to Wu discloses a further typical connector of hand tool comprising an operating member selectively coupled or attached to a main body with a spring-biased ball. However, the operating member may not be selectively and solidly secured to the main body and may not be selectively and rotatably attached to the main body. The typical connectors may not be provided to rotate or drive the spark plugs that are normally engaged or located in the tiny spaces or the like in the engine chambers of the vehicles.

The present invention has arisen to mitigate and/or obviate the afore-described disadvantages of the conventional tool connecting devices.

### SUMMARY OF THE INVENTION

The primary objective of the present invention is to provide a tool connecting device for connecting a tool member or a fastener or a work piece or a driven member to a shaft to allow the tool member or the fastener or the work piece or the driven member to be selectively secured to the shaft and rotated in concert with the shaft or to be driven by the shaft or to be selectively tiltable or slantable relative to the shaft to various angular positions, and to allow the shaft to be rotated or driven or worked in tiny or narrower working spaces.

In accordance with one aspect of the invention, there is provided a tool connecting device comprising a shaft including a first end having an engaging hole formed therein for selectively receiving and for engaging with a driven member, and including a second end having a non-circular socket opening formed therein and having at least one flat surface formed therein, a retaining member attached to the shaft, a tool member including an engaging hole formed in a first end portion thereof for engaging with a driving member, and including a non-circular rotatable member provided on a second end portion thereof and selectively engaged with the non-circular socket opening of the shaft and having at least one curved surface formed therein for selectively engaging with the non-circular socket opening and the flat surface of the shaft, to allow the tool member to be selectively tilted relative to the shaft to different angular position, and the tool member including a peripheral depression formed therein for forming a diameter reduced neck portion and arranged for allowing the tool member to be slanted and tilted relative to the shaft to different angular position, the retaining member of the shaft being selectively engaged with the rotatable member of the tool member for anchoring the rotatable member of the tool member to the shaft and for preventing the rotatable member of the tool member from being disengaged from the shaft, the second end portion of the tool member being selectively engageable into the socket opening of the shaft to solidly anchor and secure the rotatable member of the tool member to the shaft and to prevent the tool member from being slanted or tilted relative to a longitudinal axis of the shaft and to allow the tool member to be retained in line with the longitudinal axis of the shaft, a magnetic member disposed in the shaft for attracting the rotatable member of the tool member to the shaft, the shaft including an inner peripheral swelling extended radially and inwardly into the socket opening thereof to form a bore therein and to receive the magnetic member therein, and a spring-biased projection attached to the tool member for engaging with the shaft and for anchoring the rotatable member of the tool member to the shaft, the spring-biased projection being extended out from the curved surface of the tool member for engaging with the flat surface of the shaft.

The tool member includes a protrusion extended from the tool member for selectively engaging with the socket opening of the shaft to solidly anchor the rotatable member of the tool member to the shaft and to prevent the tool member from being tilted relative to the shaft. The protrusion of the tool member is preferably a hexagonal protrusion.

The shaft includes a compartment formed therein to receive a barrel, and the magnetic member is engaged into the barrel. The barrel includes a serrated outer peripheral surface for frictionally engaging with the shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a tool connecting device in accordance with the present invention;

FIG. 2 is a partial cross sectional view of the tool connecting device;

FIG. 3 is a partial cross sectional view similar to FIG. 2, illustrating the operation of the tool connecting device;

FIG. 4 is a partial cross sectional view similar to FIGS. 2-3, illustrating the other arrangement or application of the tool connecting device; and

FIG. 5 is a partial cross sectional view similar to FIGS. 2-4, illustrating the further arrangement or application of the tool connecting device.

### DETAILED DESCRIPTION OF THE PREFERRED EMBODIMENT

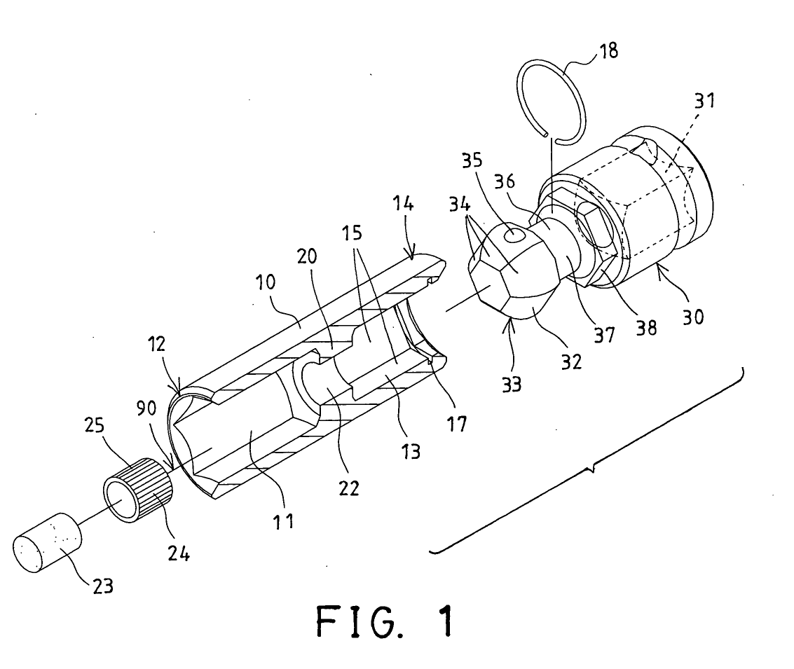

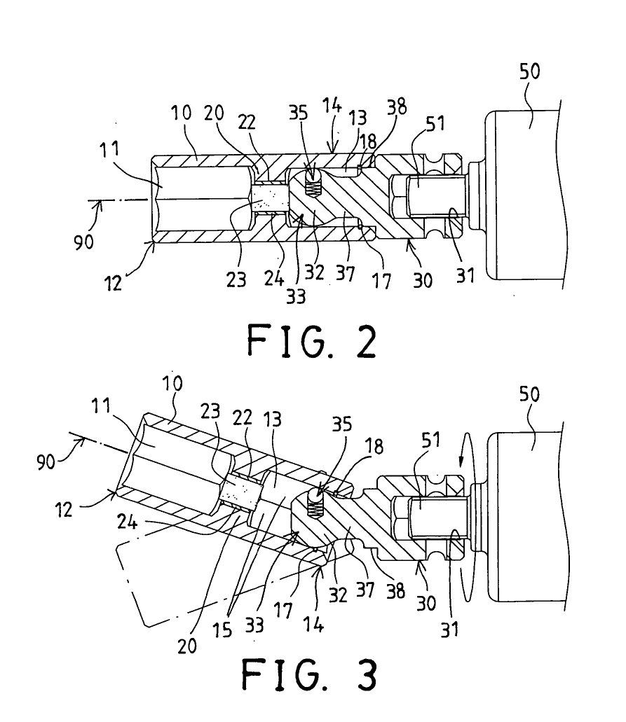

Referring to the drawings, and initially to FIGS. 1-2, a tool connecting device in accordance with the present invention comprises a shaft 10 including an engaging hole 11 provided or formed in one end 12 thereof for receiving and for engaging with and for coupling to various driven members (not shown) therein, such as spark plugs, lock nuts, fasteners, tool members or work pieces (not shown), or the like, and including a socket opening 13 formed in the other end 14 thereof for slidably and/or rotatably or pivotally receiving a tool member 30. The driven member may include a non-circular or hexagonal member (not shown) provided thereon for engaging with the engaging hole 11 of the shaft 10 and for allowing the driven members to be rotated or driven by the shaft 10.

It is preferable that the socket opening 13 of the shaft 10 includes a non-circular cross section, such as a hexagonal cross section having one or more flat surfaces 15 formed therein, and includes a peripheral groove 17 formed in the inner peripheral portion thereof for receiving or engaging with a clamping or retaining member 18 therein. The shaft 10 further includes an inner peripheral swelling 20 extended radially and inwardly into the engaging hole 11 or into the socket opening 13 thereof to form a bore 22 therein and to receive or to attach or to secure a magnetic member 23 therein. It is preferable that the bore 22 of the shaft 10 is located between and communicating with the socket opening 13 and the engaging hole 11 of the shaft 10, for allowing the magnetic member 23 also to be disposed and located between the socket opening 13 and the engaging hole 11 of the shaft 10.

For solidly attaching or securing the magnetic member 23 to the shaft 10, the magnetic member 23 may first be engaged into a barrel 24, and the barrel 24 may include a rough or serrated outer peripheral surface 25 formed on the outer peripheral portion thereof (FIG. 1) for frictionally or solidly engaging into the bore 22 of the shaft 10 and for allowing the barrel 24 and thus the magnetic member 23 to be easily and quickly attached or secured to the shaft 10 by forcing the barrel 24 into the shaft 10 and with a force-fitted engagement.

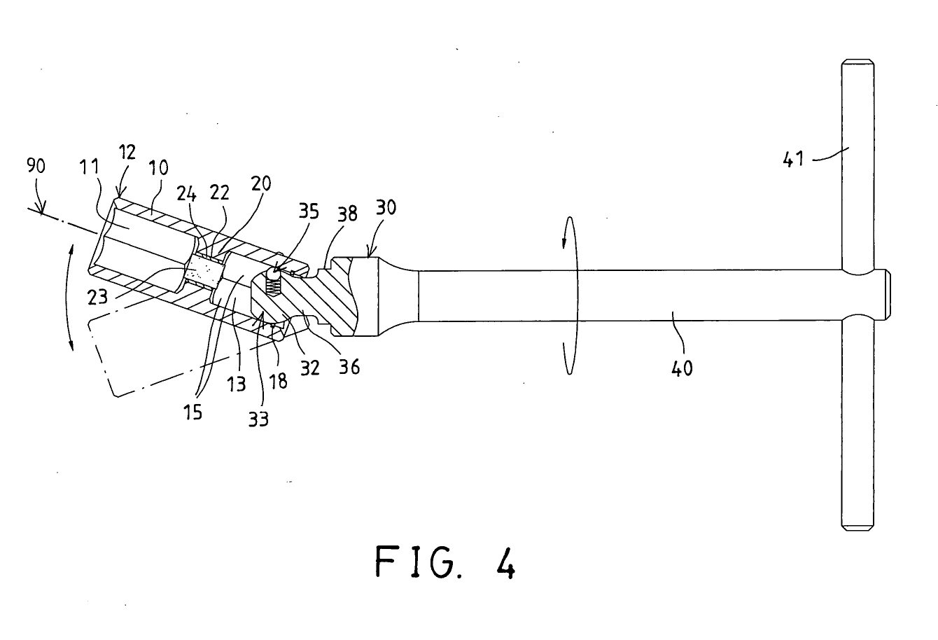

The tool member 30 also includes an engaging hole 31 provided or formed in one end portion thereof for engaging with a driving member 51 of various driving tools 50, such as wrenches, power tools, tool extensions, etc. and for coupling to the driving tools 50 and thus for allowing the tool member 30 to be rotated or driven by the driving tools 50, and includes a rounded or spherical or rotatable member 32 formed or provided on the other end 33 thereof and tiltably or slantably received in the socket opening 13 of the shaft 10 (FIGS. 2, 3) for allowing the tool member 30 to be selectively tilted or slanted relative to the longitudinal axis 90 of the shaft 10 when the rounded or spherical or rotatable member 32 of the tool member 30 is engaged in the socket opening 13 of the shaft 10.

The rotatable member 32 of the tool member 30 includes a non-circular cross section, such as a hexagonal cross section having one or more curved or flat surfaces 34 formed in outer peripheral portion thereof for engaging with the corresponding non-circular socket opening 13 and/or the corresponding flat surfaces 15 of the shaft 10 for allowing the rotatable member 32 to be tilted relative to the longitudinal axis 90 of the shaft 10 to different angular position as shown in FIG. 3, and also for allowing the rotatable member 32 to be rotated or driven by the shaft 10 when the shaft 10 is rotated or driven by the driving tools 50, by the engagement of the curved surfaces 34 of the tool member 30 and the flat surfaces 15 of the shaft 10.

The tool member 30 includes one or more spring-biased projections 35 attached thereto and partially extended out from either of the curved surfaces 34 thereof for engaging with either of the flat surfaces 15 of the shaft 10 and for suitably positioning or anchoring the rotatable member 32 of the tool member 30 to the shaft 10. In addition, the magnetic member 23 may also be used to attract the rotatable member 32 of the tool member 30 or the driven members to the shaft 10 and to further position or anchor the rotatable member 32 of the tool member 30 or the driven members to the shaft 10.

The tool member 30 further includes a peripheral depression 36 formed therein, such as formed in the middle portion thereof and located between the rotatable member 32 and the shaft 30 for forming a diameter reduced neck portion 37 and for selectively engaging with the retaining member 18 (FIG. 3) which may anchor and secure the rotatable member 32 of the tool member 30 in engagement with the shaft 10, and for preventing the rotatable member 32 of the tool member 30 from being disengaged from the shaft 10. The formation or the provision of the neck portion 37 and the peripheral depression 36 in the tool member 30 allows the tool member 30 to be suitably and selectively slanted or tilted relative to the longitudinal axis 90 of the shaft 10 to any selected or different angular position.

The tool member 30 further includes a peripheral or hexagonal protrusion 38 formed thereon or extended therefrom, such as formed and located closer to the shaft 30 but spaced away from or distal to the rotatable member 32 for selectively engaging with or into the socket opening 13 of the shaft 10 when the rotatable member 32 of the tool member 30 is completely engaged into the socket opening 13 of the shaft 10 (FIG. 2), in order to stably or solidly anchor or secure the rotatable member 32 of the tool member 30 to the shaft 10 and to prevent the tool member 30 from being slanted or tilted relative to the longitudinal axis 90 of the shaft 10. The driven members which are engaged or located in the tiny spaces or the like may thus be easily rotated or driven by the shaft 10.

In operation, as shown in FIG. 2, the peripheral protrusion 38 or the other end 33 of the tool member 30 may be selectively engaged with or into the socket opening 13 of the shaft 10 to stably or solidly anchor or secure the rotatable member 32 of the tool member 30 to the shaft 10 and to prevent the tool member 30 from being slanted or tilted relative to the longitudinal axis 90 of the shaft 10 and to allow the tool member 30 to be retained in line with the longitudinal axis 90 of the shaft 10. As shown in FIG. 3, when the peripheral protrusion 38 of the tool member 30 is selectively disengaged from the socket opening 13 of the shaft 10, the tool member 30 may be suitably and selectively slanted or tilted relative to the longitudinal axis 90 of the shaft 10 to different angular position. The engagement of the curved surfaces 34 of the tool member 30 with the flat surfaces 15 of the shaft 10 allows the shaft 10 to be rotated or driven by the tool member 30 even when the tool member 30 is slanted or tilted relative to the longitudinal axis 90 of the shaft 10 to different angular position.

The peripheral protrusion 38 of the tool member 30 may be used or acted as an anchoring means or device for selectively anchoring or securing the tool member 30 and the shaft 10 together, and for anchoring or retaining the tool member 30 in line with the shaft 10 and for preventing the tool member 30 from being tilted relative to the shaft 10 to the other angular positions. When the peripheral protrusion 38 of the tool member 30 is disengaged or separated from the socket opening 13 of the shaft 10 and/or when the retaining member 18 is selectively engaged with the peripheral depression 36 of the tool member 30, the rotatable member 32 of the tool member 30 may be anchored or secured or retained in engagement with the shaft 10 to prevent the rotatable member 32 of the tool member 30 from being disengaged from the shaft 10, but to allow the tool member 30 to be suitably and selectively slanted or tilted relative to the longitudinal axis 90 of the shaft 10 to different angular position.

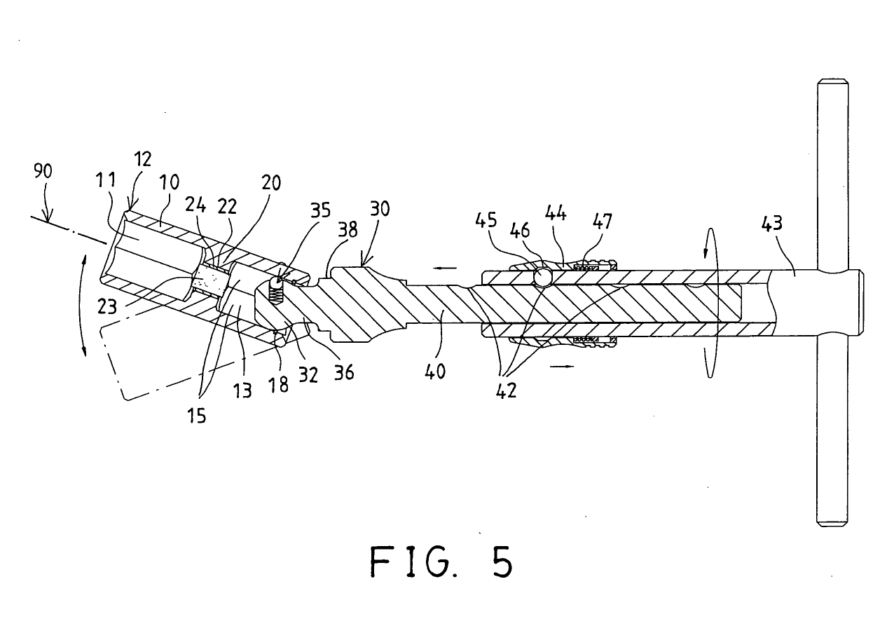

Alternatively, as shown in FIG. 4, the tool member 30 may further include a longitudinal stem 40 having a handle 41 attached to one end of the stem 40 for rotating or driving the tool member 30 to rotate or drive the shaft 10 and the driven members. Further alternatively, as shown in FIG. 5, the longitudinal stem 40 of the tool member 30 may further include one or more recesses 42 formed therein, and a tube 43 slidably engaged onto the stem 40 and anchored or positioned or secured to the stem 40 with a sleeve 44 and a detent 45. For example, the sleeve 44 includes a peripheral cavity 46 formed therein for selectively receiving the detent 45 and for allowing the detent 45 to be disengaged from the stem 40 and thus for allowing the tube 43 to be slid or moved or adjusted along the stem 40 to any selected position.

When the detent 45 is aligned with either of the recesses 42 of the stem 40 and when the peripheral cavity 46 of the sleeve 44 is disengaged from the detent 45, the sleeve 44 may engage with the detent 45 and may force the detent 45 to engage with the recess 42 of the stem 40 and thus to stably anchor or position the tube 43 to the stem 40 at the selected position. A spring member 47 may be engaged into the sleeve 44 and engaged with the tube 43 for biasing the sleeve 44 to move relative to the tube 43 and to disengage the peripheral cavity 46 of the sleeve 44 from the detent 45 and thus to solidly anchor or position the tube 43 to the stem 40 at the selected position.

Accordingly, the tool connecting device in accordance with the present invention may be provided for connecting a tool member or a fastener or a work piece or a driven member to a shaft to allow the tool member or the fastener or the work piece or the driven member to be selectively secured to the shaft and rotated in concert with the shaft or to be rotated or driven by the shaft or to be selectively rotatable relative to the shaft to various angular positions.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool connecting device comprising:
a shaft including a first end having an engaging hole formed therein for selectively receiving and for engaging with a driven member, and including a second end having a non-circular socket opening formed therein and having at least one flat surface formed therein,
a retaining member attached to said shaft,
a tool member including an engaging hole formed in a first end portion thereof for engaging with a driving member, and including a non-circular rotatable member provided on a second end portion thereof and selectively engaged with said non-circular socket opening of said shaft and having at least one curved surface formed therein for selectively engaging with said non-circular socket opening and said at least one flat surface of said shaft, to allow said tool member to be selectively tilted relative to said shaft to different angular position, and said tool member including a peripheral depression formed therein for forming a diameter reduced neck portion and arranged for allowing said tool member to be slanted and tilted relative to said shaft to different angular position,
said retaining member of said shaft being selectively engaged with said rotatable member of said tool member for anchoring said rotatable member of said tool member to said shaft and for preventing said rotatable member of said tool member from being disengaged from said shaft,
said second end portion of said tool member being selectively engageable into said socket opening of said shaft to solidly anchor and secure said rotatable member of said tool member to said shaft and to prevent said tool member from being slanted or tilted relative to a longitudinal axis of said shaft and to allow said tool member to be retained in line with the longitudinal axis of said shaft,
a magnetic member disposed in said shaft for attracting said rotatable member of said tool member to said shaft, said shaft including an inner peripheral swelling extended radially and inwardly into said socket opening thereof to form a bore therein and to receive said magnetic member therein, and
a spring-biased projection attached to said tool member for engaging with said shaft and for anchoring said rotatable member of said tool member to said shaft, said spring-biased projection being extended out from said at least one curved surface of said tool member for engaging with said at least one flat surface of said shaft.

2. The tool connecting device as claimed in claim 1, wherein said tool member includes a protrusion extended from said tool member for selectively engaging with said socket opening of said shaft to solidly anchor said rotatable member of said tool member to said shaft and to prevent said tool member from being tilted relative to said shaft.

3. The tool connecting device as claimed in claim 2, wherein said protrusion of said tool member is a hexagonal protrusion.

4. The tool connecting device as claimed in claim 1, wherein said shaft includes a compartment formed therein to receive a barrel, and said magnetic member is engaged into said barrel.

5. The tool connecting device as claimed in claim 4, wherein said barrel includes a serrated outer peripheral surface for frictionally engaging with said shaft.
